(19) United States
(12) Patent Application Publication
(10) Pub. No.: US 2010/0138680 A1
(43) Pub. Date: Jun. 3, 2010

(54) AUTOMATIC DISPLAY AND VOICE COMMAND ACTIVATION WITH HAND EDGE SENSING

(75) Inventors: Arthur Brisebois, Cumming, GA (US); Robert S. Klein, Manchester, CT (US)

Correspondence Address: AT&T Legal Department - T&W;Attn: Patent Docketing, Room 2A-207, One AT&T Way, Bedminster, NJ, 07921, US

(73) Assignee: AT&T Mobility II LLC, Atlanta, GA (US)

(21) Appl. No.: 12/326,157

(22) Filed: Dec. 2, 2008

(51) Int. Cl. G06F 1/32

(52) U.S. Cl. 713/324

(57) ABSTRACT

Systems and methodologies for adapting input/output operation of an electronic device for in-hand and out-of-hand scenarios are provided herein. As described herein, sensors (e.g., capacitive, resistive, touch-sensitive, etc.) are applied to respective outer edges of a device to determine whether the device is in a user's hand. Subsequently, the determination can be utilized to automatically select an input/output mode for the device and to selectively activate one or more input/output mechanisms associated with the device. For example, if a device is determined to be in-hand, mechanical input/output mechanisms, such as a touch-screen or keypad, can be enabled. Alternatively, if a device is determined to be out-of-hand, a touch-screen at the device can be disabled to conserve power and alternative input/output mode, such as voice input/output, can be enabled. As further described herein, in- and/or out-of-hand behavior for a device can be specified on a per-application or per-application type basis.

### TECHNICAL FIELD

The following disclosure relates generally to portable electronic devices, and more particularly to techniques for providing input to a portable electronic device.

### BACKGROUND

As handheld electronic devices, such as mobile telephone handsets, electronic game controllers, and the like, increase in prevalence and increase in processing power, displays for such devices are becoming larger, more complex, and more power-hungry. For example, many existing electronic devices are equipped with touch-screens to facilitate the entry of input despite the size-constrained nature of the associated devices. However, touch-screens and similar input mechanisms utilize a large amount of power for both output (e.g., lighting) and input activity, which results in reduced battery life for devices that utilize such mechanisms. Further, existing electronic devices generally rely on an activity-based and/or time-based mechanism to determine whether to provide lighting to a device display, which can result in additional excess power usage during periods where a user is not actively engaged in viewing the display and/or otherwise actively using the device.

Some existing handheld electronic devices can utilize multiple input/output modes to provide an efficient and intuitive user experience for a variety of applications that utilize the device. However, such devices traditionally require a user to manually switch between input/output modes, which can result in reduced user-friendliness as well as potential safety risks in certain situations (e.g., a situation in which a user is driving). Accordingly, it would be desirable to implement input/output mechanisms for handheld devices that mitigate at least the above shortcomings.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

Systems and methodologies are provided herein that facilitate automatic input/output adaptation for a handheld electronic device. In accordance with various aspects described herein, sensors and/or other suitable means can be employed by a handheld electronic device to determine whether the device is in a user's hand. Based on the result of this determination, an input/output mode for the device can be automatically selected to provide an optimal user experience in terms of device power usage, user-friendliness, safety, and/or other factors.

In accordance with one aspect, sensors (e.g., capacitive sensors, resistive sensors, pressure sensors, etc.) can be placed along one or more side and/or back edges of a device to perform various measurements relating to contact between a user and the device edges at which the sensors are placed. For example, the sensors can be utilized to detect and report the presence or absence of skin contact at various points along the edges of a device. Based on these measurements, a determination can be made regarding whether the device is located in a user's hand. If the device is determined to be in the user's hand, a touch-screen for the device and/or one or more other mechanical input/output mechanisms can be enabled. Otherwise, if the device is determined not to be in the user's hand, a touch-screen can be disabled to conserve device power and an alternative input/output mechanism, such as a microphone and speakers for voice input/output, can be enabled.

In accordance with another aspect, in- and/or out-of-hand behavior can be specified on a per-application or per-application type basis. For example, a device executing a video-based application while out of hand can utilize a display screen and/or other means for displaying the video while a device executing another type of application while out of hand can disable the display. In one example, information relating to in- and/or out-of-hand behavior for various applications and/or application types can be specified by the applications themselves and/or by a user of the device.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 is a block diagram of a system for controlling a handheld device in accordance with various aspects.

FIG. 2 illustrates an example sensor implementation for an electronic device in accordance with various aspects.

FIG. 3 is a block diagram of a system for controlling a handheld device in accordance with various aspects.

FIGS. 4-5 illustrate example implementations of an edge sensor in accordance with various aspects.

FIG. 6 is a block diagram of a system for processing sensor contacts in accordance with various aspects.

FIG. 7 illustrates example measurements relating to sensor contacts that can be performed in accordance with various aspects.

FIG. 8 is a block diagram for associating a soft key mapping with a sensor in accordance with various aspects.

FIG. 9 is a block diagram of a system for automatic input/output adaptation for an electronic device in accordance with various aspects.

FIG. 10 is a block diagram of a system for selecting an input/output mode for an electronic device based on sensor information in accordance with various aspects.

FIGS. 11-12 illustrate an example technique for in- and out-of-hand input/output adjustment for an electronic device in accordance with various aspects.

FIGS. 13-14 are flowcharts of respective methods for adapting a handheld device for in-hand or out-of-hand operation.

FIG. 15 is a block diagram of a computing system in which various aspects described herein can function.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, it is to be appreciated that while various drawings are provided herein to illustrate respective example embodiments of the claimed subject matter, the embodiments illustrated herein are not necessarily to be construed as preferred or advantageous over other aspects or designs, nor are they meant to preclude equivalent structures and techniques known to those of ordinary skill in the art. Furthermore, it is to be appreciated that the various drawings are not drawn to scale from one figure to another nor inside a given figure, and in particular that the size of the components are arbitrarily drawn for facilitating the reading of the drawings.

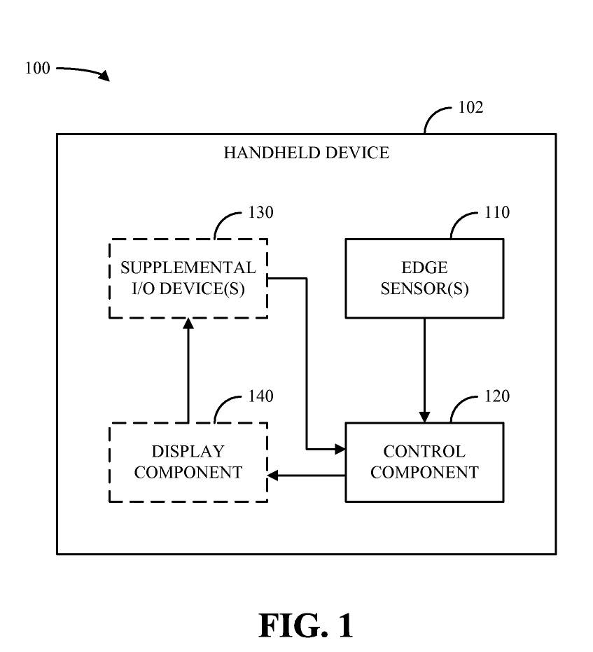

Referring now to the drawings, FIG. 1 illustrates a block diagram of a system 100 for controlling a handheld device 102 in accordance with various aspects described herein. It can be appreciated that handheld device 102 illustrated by FIG. 1 can be any suitable device, such as portable and/or non-portable electronic devices or the like. Examples of handheld devices 102 that can be utilized include, but are not limited to, mobile telephone handsets, electronic game systems and/or game controllers, musical instruments, Global Positioning System (GPS) receivers, Personal Digital Assistants (PDAs), smartphones, package tracking devices, laptop and/or tablet computers, virtual reality systems, and/or any other appropriate type of device.

In accordance with one aspect, handheld device 102 can include one or more edge sensors 110 to provide improved input functionality by facilitating additional control options in a limited amount of space provided at the device 102. For example, edge sensor(s) 110 can be applied to one or more side and/or back edges of a device, thereby allowing inputs normally associated with a touch-screen and/or a mechanical button, dial, or other control to be implemented using the sides of the device 102. As a result, input functions conventionally executed by controls at the front of a device can be moved to traditionally unused space at the sides and/or back of the device, which in turn can facilitate the use of larger device display areas at the front of the device and entry of user input without obstructing the display area (e.g., by engaging a touch-screen). In addition, it can be appreciated that edge sensors 110 can provide input functionality similar to that achieved by conventional mechanisms such as touch-screens without the power requirements ordinarily associated with such mechanisms.

In accordance with one aspect, edge sensors 110 can utilize capacitive, resistive, touch-sensitive, and/or any other suitable sensing technology to detect the presence and/or motion of a user's fingers and/or hands with respect to the edges of an associated device 102. For example, edge sensors 110 can be utilized to monitor the presence or absence of skin contact at various points along the edges of a handheld device. Further, when presence of skin contact is detected, various parameters of various contact points, such as the location, width, spacing, count, pressure, and/or movement of the contact points, can be utilized by the edge sensors 110 to infer the presence and location of a user's hands and/or fingers along the edges of the device 102. In one example, this information can be provided to a control component 120, which can facilitate the control of one or more features and/or applications executed by the device 102. For example, the control component 120 can facilitate a mapping of various points along edge sensor(s) 110 to respective soft keys, which can be manipulated by a user to control operation of the device 102.

In accordance with another aspect, inputs provided by edge sensor(s) 110 can be utilized by the control component 120 in combination with one or more optional supplemental input/output (I/O) device 130, such as a keyboard, numeric keypad, touch-screen, trackball, keyboard, mouse, etc., to provide input for one or more applications and/or features of the device 102. In another example, the control component 120 can manage an optional display component 140 to provide visual information relating to one or more applications and/or features of a handheld device 102 being executed by a user.

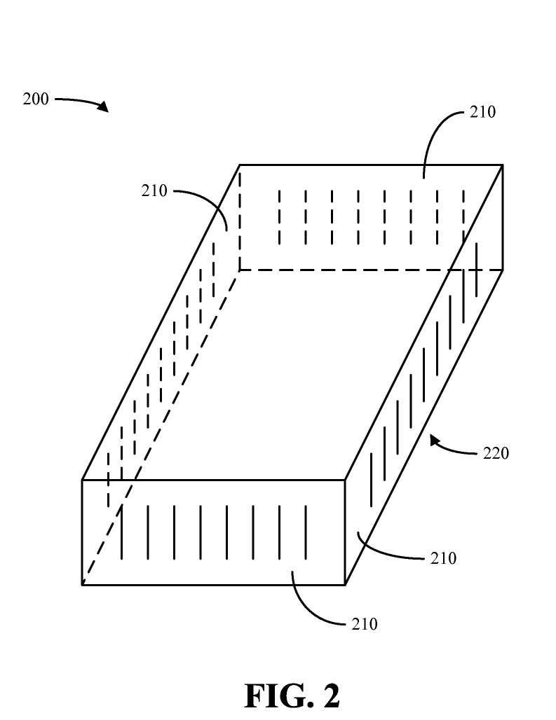

Turning now to FIG. 2, a diagram 200 is provided that illustrates an example sensor implementation for an electronic device (e.g., handheld device 102) in accordance with various aspects. In one example, a device as illustrated by diagram 200 can be provided, to which one or more edge sensors 210 can be affixed and/or otherwise placed at the side edges of the device. Additionally and/or alternatively, a back sensor 220 can be placed at the back edge of the device.

In accordance with one aspect, side sensors 210 and/or a back sensor 220 can be faceted, such that a plurality of touch points are provided along the length of each sensor 210 and/or 220. As illustrated in diagram 200, touch points at side sensors 210 are divided by vertical lines along each sensor 210. Additionally and/or alternatively, it can be appreciated that touch points could also be implemented across the width of the sensors 210 and/or 220, thereby creating a two-dimensional array of touch points across each sensor 210 and/or 220.

In accordance with another aspect, edge sensors 210 and/or back sensor 220 can be implemented using any suitable sensing technology or combination of technologies, such as capacitive sensing, resistive sensing, touch or pressure sensing, and/or any other suitable sensing technology that can be placed along the edges of an associated device as illustrated by diagram 200. While various example implementations are described herein in the context of capacitive sensing, it should be appreciated that capacitive sensing is only one implementation that can be utilized and that, unless explicitly stated otherwise in the claims, the claimed subject matter is not intended to be limited to such an implementation.

As illustrated by diagram 200, sensors 210 and 220 can be placed along the side and back edges of an associated device, respectively, in order to allow the sides and/or back of an electronic device to be utilized for providing input to the device. Accordingly, it can be appreciated that the sensor implementation illustrated by diagram 200 can facilitate user input without requiring a user to obstruct a display area located at the front of a device to enter such input, in contrast to conventional input mechanisms such as touch-screens or mechanical controls located at the front of a device. Further, side sensor(s) 210 and/or back sensor 220 can additionally be utilized to detect and monitor a plurality of contacts simultaneously, thereby facilitating a rich, intuitive user input experience that is similar to that associated with multi-touch touch-screens and other similar input mechanisms without incurring the cost traditionally associated with such input mechanisms. Moreover, due to the rich, intuitive user input experience provided by sensors 210 and/or 220, various applications can be enabled at an associated device that would otherwise be impractical for a handheld device.

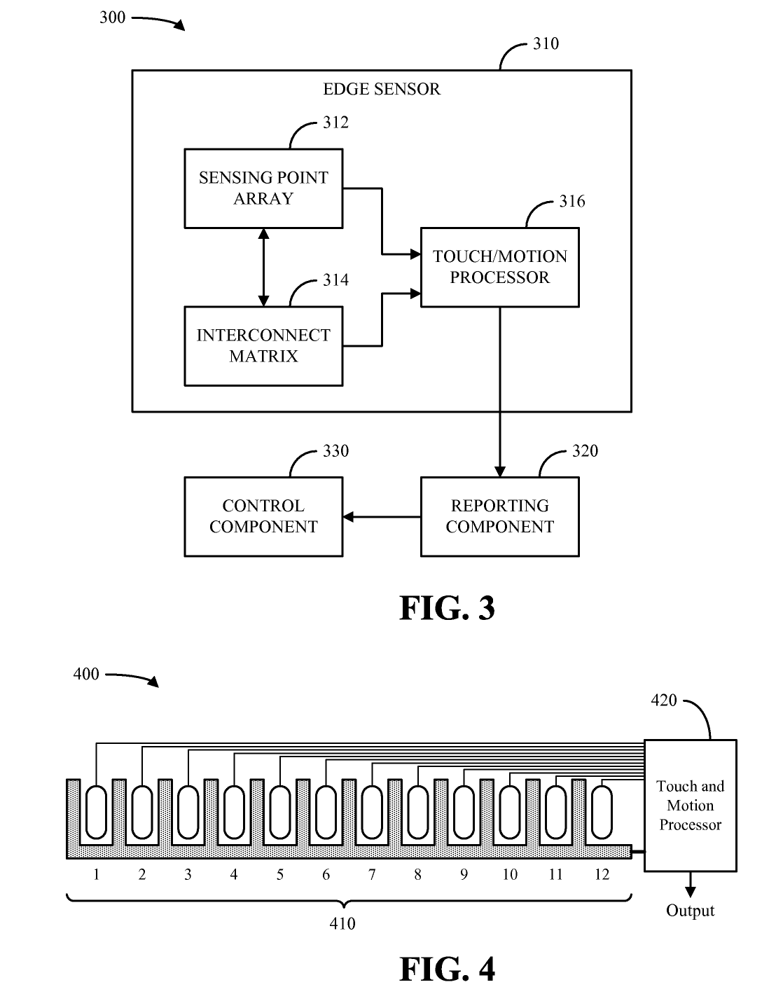

Referring now to FIG. 3, a system 300 for controlling a handheld device in accordance with various aspects is illustrated. In one example, system 300 can include an edge sensor 310, which can be applied to one or more outer edges of an associated device as generally described herein. In accordance with one aspect, edge sensor 310 can include one or more sensing points arranged in a linear array 312 and an interconnection matrix 314 that joins the sensing points in the array 312.

In one example, edge sensor 310 can be segmented as illustrated by diagram 200 such that various sensing points in the sensing point array 312 correspond to respective locations along the edge sensor 310. Accordingly, the sensing point array 312 and/or interconnection matrix 314 can be monitored by a touch and motion processor 316 that detects and reports the presence or absence of skin contact (e.g., from a user's hands and/or fingers) at various points along the edge sensor 310 based on changes in capacitance, resistance, pressure, or the like observed at the sensing points. In accordance with one example, a reporting component 320 can be utilized to report information obtained by the touch and motion processor 316 to a control component 330, which can in turn utilize the information as input for one or more applications.

In one example, touch and motion processor 316 can monitor relationships between adjacent sensing points, the grouping of contacts, separation of contact points, a number of detected contact points, and/or other similar observations to detect the presence and/or positioning of the hands and/or fingers of a user relative to the edge sensor 310. Techniques by which the touch and motion processor 316 can perform such monitoring and detection are described in further detail infra.

Turning to FIG. 4, a diagram 400 is provided that illustrates an example edge sensor that can be implemented in accordance with various aspects described herein. As diagram 400 illustrates, an edge sensor can include an array of sensing points 410, which can be joined by an interconnection matrix and/or coupled to a touch and motion processor 420. In accordance with one aspect, sensing points 410 can utilize changes in capacitance, resistance, pressure, and/or any other suitable property or combination of properties to sense the presence or absence of skin contact with the sensing points 410. Diagram 400 illustrates an array of 12 sensing points 410 for purposes of clarity of illustration; however, it should be appreciated that any number of sensing points 410 can be utilized in conjunction with an edge sensor as described herein.

In one example, the touch and motion processor 420 can utilize information obtained from one or more sensing points-410 and/or a related interconnection matrix to measure and report edge contact presence, location, width, spacing, count, pressure, movement, and/or any other suitable property on a periodic basis (e.g., via a reporting component 320). These reports can subsequently be used by various applications at an associated device (e.g., via a control component 330) that are configured to utilize control inputs from a device edge associated with the sensor illustrated by diagram 400. For example, one or more applications can utilize information reported from the touch and motion processor 420 to control soft keys that are mapped to respective portions of the sensing points 410, as described in further detail infra.

By way of specific, non-limiting example, the sensing points 410 can utilize capacitive sensing such that respective sensing points 410 exhibit a capacitance when in contact with human skin (e.g., from a user's hand and/or fingers). Based on these capacitances and changes thereto, the touch and motion processor 420 can determine relationships between adjacent sensing points 410, grouping between contacts, separation between contact points, the number of detected contacts, and/or other appropriate factors for determining the presence, location, and/or movement of the hands and/or fingers of a user with respect to the sensor.

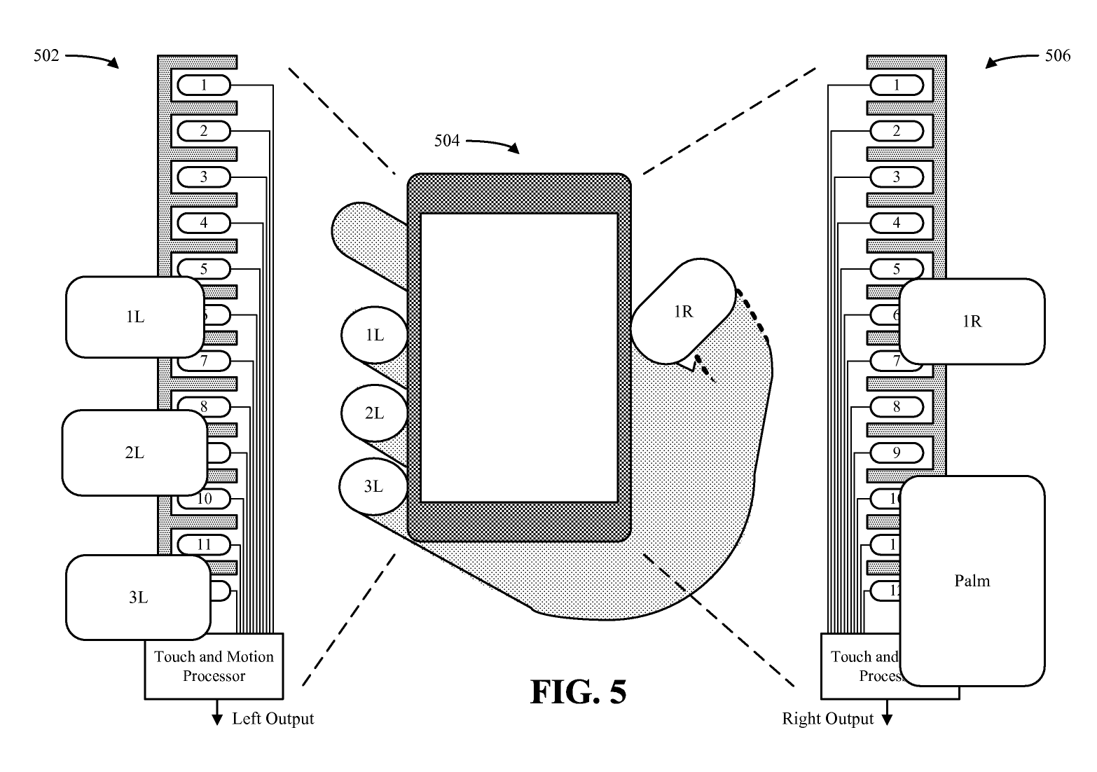

An example application of the edge sensor illustrated by diagram 400 is provided in FIG. 5. In accordance with one aspect, FIG. 5 illustrates an example portable device having edge sensors along the left and right edges of the device. More particularly, diagram 504 illustrates a front view of the device, while diagrams 502 and 506 respectively provide detailed illustrations of the left and right edge sensors employed on the device. While detail view diagrams 502 and 506 illustrate respective edge sensors having 12 touch points, it should be appreciated that any suitable number of touch points can be utilized and that respective sensors utilized with a common device can have uniform and/or non-uniform numbers of associated touch points. Further, it should be appreciated that while a generic electronic device is illustrated in diagram 504 for simplicity, the implementations illustrated by FIG. 5 could be utilized for any suitable electronic device, such as, for example, a mobile telephone handset, an electronic game system and/or game controller, a musical instrument (e.g., an electronic keyboard, guitar, etc.), a GPS receiver, a PDA, a smartphone, a package tracking device (e.g., a barcode scanner), a computer (e.g., a desktop, laptop, and/or tablet computer), a virtual reality device, and/or any other appropriate type of device.

As the front view diagram 504 illustrates, a user can hold the portable device with his right hand, such that the thumb, denoted as 1R, and palm of the user rest against the right side of the device while three fingers of the user, denoted as 1L-3L, rest against the left side of the device. Accordingly, as shown in left detail view diagram 502, the three fingers of the user resting against the left side of the device can contact sensing points on the left sensor implemented on the device, which can in turn cause a change in the properties of the contacted sensing points. Based on these changes in properties, a touch and motion processor for the left edge sensor can determine the number, spacing, width, and/or other properties of each contact, from which it can infer that the user has rested his fingers against the left side of the device. In one example, information relating to user contact with the left edge sensor can be relayed as left sensor output to one or more other components of the device to be utilized as input and/or for further processing.

Similarly, as illustrated by right side detail view diagram 506, a touch and motion processor for the right edge sensor can detect changes in the properties of sensing points at which the user's thumb and/or palm have contacted the right edge of the device. Based on these detected changes, the touch and motion processor for the right edge sensor can determine information relating to user contact with the right edge sensor and relay this information as output for input to one or more applications and/or for further processing.

While the left and right edge sensors are illustrated in FIG. 5 as having separate touch and motion processors, it should be appreciated that one or more sensors associated with an electronic device can share a common touch and motion processor. Further, it should be appreciated that the functionality of the touch and motion processor(s) as illustrated by FIG. 5 could also be implemented using any other suitable component(s) of an associated device, such as one or more generalized processing units provided for an electronic device. In a common processor implementation, it can additionally be appreciated that separate outputs can be provided for each sensor monitored by a processor, or alternatively outputs from a plurality of sensors can be combined into a common output.

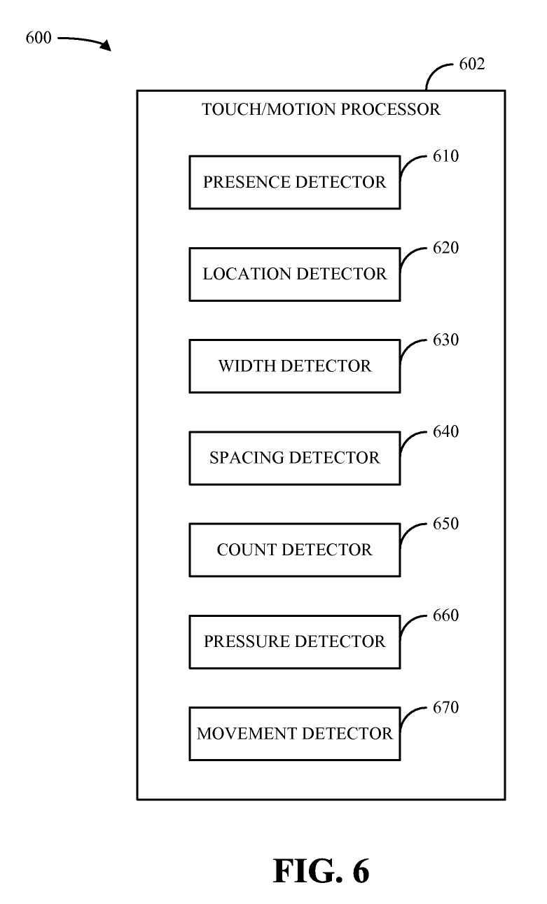

Referring now to FIG. 6, a block diagram of a system 600 for processing sensor contacts in accordance with various aspects is illustrated. In one example, system 600 can include a touch/motion processor 602 associated with a sensor applied to an electronic device. In accordance with one aspect, touch/motion processor 602 can include one or more detectors 610-670 for respectively detecting presence, location, width, spacing, count, pressure, and/or movement of touch points between an associated device edge and a user's hand. It can be appreciated that detectors 610-670 are provided by way of example and that, in various implementations, a touch/motion processor can implement fewer than the detectors 610-670 illustrated in FIG. 6 and/or one or more detectors not illustrated in FIG. 6.

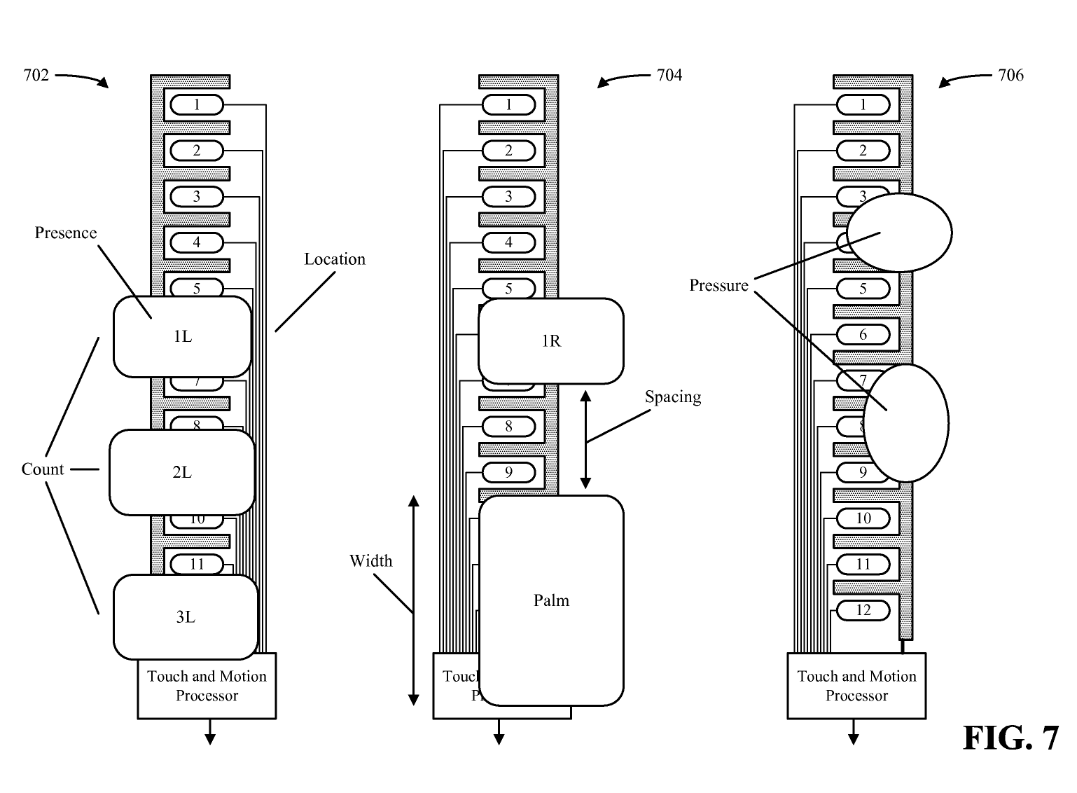

In accordance with various aspects, detectors 610-670 can operate as follows. In accordance with one aspect, presence detector 610 can detect the presence or absence of contacts between a user's hand and/or fingers and an associated edge sensor, as illustrated by diagram 702 in FIG. 7. In one example, if a given sensing point on an associated sensor exhibits a change in capacitance (or another suitable property), presence detector 610 can determine that there is contact on some point along the perimeter of the device corresponding to the sensor. In another example, contact detected by presence detector, or lack thereof, can be utilized by touch/motion processor 602 that the device is either in or out of a user's hand.

In accordance with another aspect, location detector 620 can be utilized to determine the location of one or more contacts on an associated sensor as illustrated by diagram 702 in FIG. 7. In one example, respective sensing points on an associated sensor can be numbered and have respective known locations along the sensing point array. Accordingly, when a specific sensing point exhibits a change in capacitance and/or another suitable property, location detector 620 can be utilized to determine the location of contact.

Width detector 630 can be utilized to determine the width of a contact with an associated edge sensor as illustrated by diagram 704 in FIG. 7. In one example, a substantially large number of sensing points can be provided on a sensor and spaced closely together such that a finger or palm spans multiple sensing points. Accordingly, width detector 630 can attempt to identify consecutive strings of contacted sensing points, based on which contact width can be determined. In accordance with one aspect, contact width as determined by width detector 630 can be utilized to determine whether contact was made by, for example, a finger, a palm, or a thumb of the user. In one example, width detector 630 can define the center of a contact as the middle point between the distant ends of the contacted sensing point string.

In accordance with another aspect, spacing detector 640 can be utilized to determine the spacing between multiple detected contacts, as illustrated by diagram 704 in FIG. 7. In one example, spacing detector 640 can determine spacing between contacts by identifying non-contacted sensing points that span gaps between contacted sensing points. Accordingly, it can be appreciated that small strings of non-contacted sensing points can indicate close spacing, while long strings of non-contacted sensing points can indicate distant spacing. This information can be used by touch/motion processor 602 to, for example, ascertain the relationship between contact points to determine the presence of a thumb and palm versus adjacent fingers.

In accordance with a further aspect, count detector 650 can be utilized to detect the number of distinct contacts made with an associated sensor, as illustrated by diagram 702 in FIG. 7. In one example, count detector 650 can regard respective consecutive strings of adjacent contacted sensing points as indicating an object (e.g., finger, thumb, palm, etc.) touching the associated device edge. Accordingly, count detector 650 can utilize this information to ascertain the number of objects touching one or more edges of the device.

Pressure detector 660 can be utilized to detect respective pressures of contacts to an associated sensor. In accordance with one aspect, pressure detector 660 can utilize variance in one or more properties of fingers and/or other objects contacting the sensor with pressure as illustrated by diagram 706 in FIG. 7. For example, it can be observed that fingers, palms, and the like tend to spread (e.g., creating more linear contact) as additional pressure is applied. Thus, in the example illustrated by diagram 706 in FIG. 7, a relatively light amount of pressure has been applied to the top-most contact point while heavier pressure has been applied to the lower contact point. As a result, it can be appreciated that an object influences more sensing points when pressed firmly versus lightly. Accordingly, pressure detector 660 can utilize this information to determine changes in applied pressure at one or more contact points. In one example, pressure detector 660 can measure relative changes in pressure and/or absolute pressure values at one or more contact points. In another example, the operation of pressure detector 660 can be normalized on a per-user basis in order to allow pressure detector 660 to adapt to the size, shape, and/or other properties of the hands and/or fingers of a particular user.

In accordance with another aspect, movement detector 670 can be utilized to detect movement of one or more contacts along an associated sensor. In one example, consecutive strings of contacted sensing points corresponding to a contact point can shift up and down if the object (e.g., finger, thumb, palm, etc.) making the contact is moved along the length of the sensor. Accordingly, movement detector 670 can use this information to ascertain movement of any object touching the device edge.

In one example, touch/motion processor 602 can report measurements from detectors 610-670 on a periodic basis. These reports can subsequently be utilized by, for example, various applications that are dependent on control inputs from the edge of an associated device in order to facilitate control of such applications.

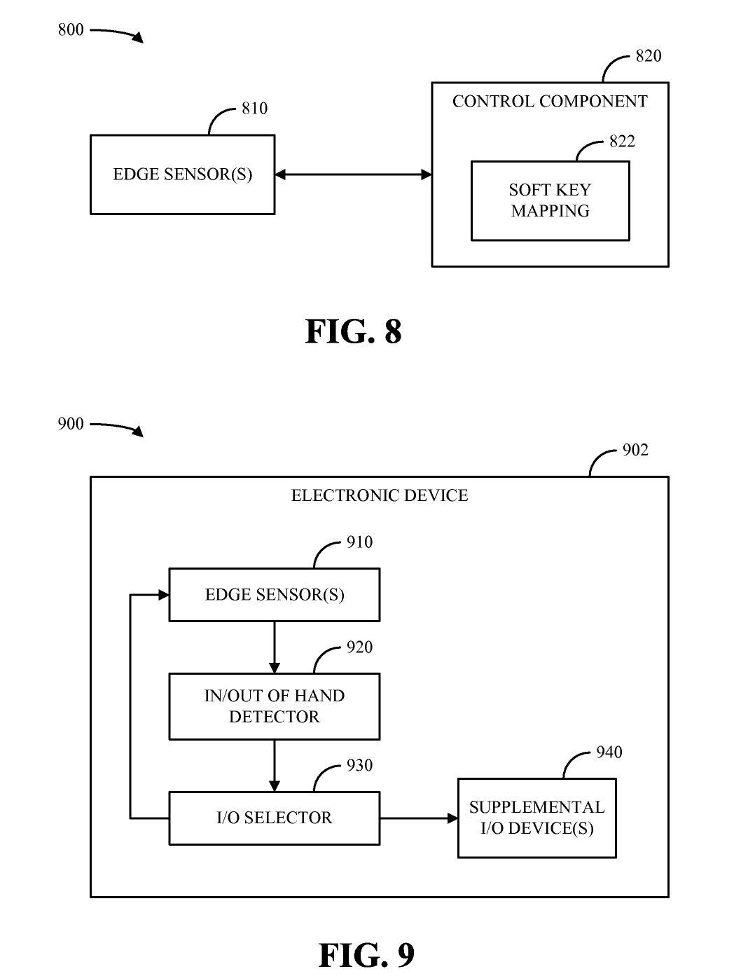

Turning to FIG. 8, a system 800 for associating a soft key mapping 822 with one or more edge sensors 810 in accordance with various aspects is illustrated. As system 800 illustrates, one or more edge sensors 810 can be utilized in combination with a control component 820 to enable a user to provide input to an associated electronic device. In one example, control component 820 can employ a soft key mapping 822 that can map various portions of the edge sensor(s) 810 to respective control regions, thereby allowing contacts and/or movement relative to mapped portions of the edge sensor(s) 810 to be interpreted as user inputs. For example, soft key mapping 822 can include one or more “button” assignments that facilitate processing a contact with a given portion of edge sensor(s) 810 as equivalent to pressing a hardware button. As another example, soft key mapping 822 can include one or more “slider” assignments that facilitate processing movement of a contact point with a given portion of edge sensor(s) as equivalent to movement of a physical slider, dial, or the like.

In accordance with one aspect, a soft key mapping 822 can be made adaptive to the manner in which a particular user holds an associated device. For example, control regions provided by soft key mapping 822 can be moved between sensors 810 and/or along a sensor 810 based on the detected positions of a user's fingers. In another example, a soft key mapping 822 can be utilized to enable an associated device to be accommodating to a user with a physical disability such as missing fingers. For example, by determining the positioning of a user's palm and/or fingers along the edges of a device based on the width, spacing, or other properties of the user's contact points with the device, information regarding the physical ability of the user can be inferred. Based on this information, the soft key mapping 822 can be adjusted to best accommodate the user's ability and to allow a user that is physically unable to utilize traditional mechanical controls such as keypads, dials, or the like to provide input to an associated device. For example, if it is determined that a user has difficulty reaching one or more portions of a device while holding the device in his hand, the soft key mapping 822 can be adjusted to avoid placing control regions at those portions.

Referring to FIG. 9, illustrated is a system 900 for automatic input/output adaptation for an electronic device 902 in accordance with various aspects. As FIG. 9 illustrates, electronic device 902 can include one or more edge sensors 910 that can determine the presence and/or movement of a user's hands or fingers with respect to the electronic device 902 as described in accordance with various aspects above. In accordance with one aspect, outputs from edge sensor(s) 910 can be provided to an in/out of hand detector 920, which can be utilized to determine whether the device 902 is being held by a user. Based on the determination of the in/out of hand detector 920, an I/O selector 930 can be utilized to automatically adapt the input/output performance of the device 902. For example, the I/O selector 930 can configure the device 902 to utilize edge sensor(s) 910 and/or one or more supplemental I/O devices 940 for input and/or output depending on whether the device 902 is in a user's hand and/or on other appropriate factors.

In accordance with one aspect, the supplemental I/O device(s) 940 can include a touch-screen that can be utilized for input and output functions of the device 902. It can be appreciated, however, that touch-screens and/or other display I/O devices can cause an associated device 902 to be prone to loss of battery life due to the fact that, for example, the display must be lit for output activity (in a similar manner to non-touch screens) as well as for input activity. For example, it can be appreciated that it is difficult to press an appropriate soft key if the soft keys cannot be seen due to insufficient lighting at the touch screen. In addition, it can be appreciated that devices that utilize display I/O mechanisms are generally unable to predict the location of a user's hands or a current area of focus of a user's eyes, which in turn results in an inability of the device to predict the need for soft key input and/or notification displays. As a result, many existing display I/O devices utilize activity- and/or time-based mechanisms to determine if the display should or should not be lit. For example, in order to ensure that the device is ready for input, existing display I/O devices generally continue to provide power to the display for a predetermined period of time following inactivity. In addition, these display I/O devices generally light the display for notification events without regard to whether the display is being viewed by the user. As a result, it can be appreciated that conventional display I/O devices can utilize excessive power due to displaying items at times in which the user is not focused on the device.

In accordance with another aspect, the supplemental I/O device(s) 940 can include one or more voice-activated I/O mechanisms that enable hands-free operation of the device 902. It can be appreciated that under certain operating conditions, such as when the device 902 is not in direct sight and/or when a user is driving, voice-activated I/O can be more user-friendly and safe. Further, it can be appreciated that voice-activated I/O can provide enhanced power efficiency as compared to display I/O under some circumstances. However, existing handheld devices are generally not able to determine whether display or voice-activated I/O is optimal for a user situation. For example, such a device may be unable to determine whether a user is holding or looking at the device, and as a result the device may be unable to determine whether display or voice I/O is optimal based on the current needs of a user. Accordingly, conventional electronic devices result in reduced user-friendliness, degraded user experience, and potential safety risks in a situation such as that involving a user manually toggling between display and voice I/O modes while driving.

Conventional electronic devices utilize various techniques in an attempt to facilitate toggling between display and voice I/O; however, these conventional techniques experience various shortcomings. For example, some electronic devices utilize face sensing in connection with a touch-screen and/or another similar display I/O device to disable the display when the device is in a “talk” position and the device is not being looked at. However, it can be appreciated that this technique is inapplicable to a situation where the device is operating in a hands-free mode, which is often recommended for use by mobile and safety groups while a user of the device is moving. In addition, some conventional devices utilize an accelerometer for determining the orientation of the device, which can then be utilized to infer an application employed by the device and an appropriate I/O mode corresponding to the application. However, this technique is often unreliable due to the fact that a handheld device can rapidly change orientation depending on the movement of a user and/or numerous other factors.

Accordingly, to mitigate the above shortcomings of conventional electronic device implementations, a device 902 can utilize the outputs of one or more edge sensors 910 to switch between I/O modes. For example, edge sensor(s) 910 can obtain information relating to the presence and/or absence of a user's hand at the outer edges of the device 902, and based on this information the in/out of hand detector 920-can determine whether the device 902 is in or out of a user's hand. In accordance with one aspect, an I/O selector 930 can be utilized to activate and/or deactivate the edge sensor(s) 910 and/or supplemental I/O device(s) 940 based on the determination of the in/out of hand detector 930.

In one example, if the in/out of hand detector 920 determines that the device 902 is out of a user's hand, it can be appreciated that the usefulness of a display at the device 902 is limited for substantially all applications utilized by the device 902 except for those that provide only video output (e.g., media player and mapping applications). In addition, it can be appreciated in such a scenario that a user's fingers are not near the touch-screen of the device 902 and that, aside from the aforementioned video applications, a user is unlikely to be looking at the display. Accordingly, in one example, the I/O selector 930 can substantially immediately deactivate a display associated with the device 902 (e.g., without an inactivity timer) as soon as the in/out of hand detector 920 determines that hand and finger presence has been lost on all front sensors and/or edge sensors 910 of the device 902, unless it is further determined that the device 902 is executing a video application. In another example, upon determining that the device 902 has left a user's hand, the I/O selector 930 can additionally trigger voice I/O without waiting for an inactivity timer for some or all applications.

Alternatively, if the in/out of hand detector 920 determines that the device 902 is in a user's hand, the I/O selector 930 can infer that the user is touching and looking at the device 902. Accordingly, because the user's fingers are near one or more display I/O mechanisms at the device 902 and soft key input generally requires a line of sight to a display at the device 902, I/O selector 930 can enable display I/O, input from edge sensor(s) 910, and/or other similar I/O mechanisms. In one example, I/O selector 930 can enable display output at the earlier of expiration of an activity timer or removal of the device 902 from the user's hand. In another example, I/O selector 930 can disable voice I/O at the-device 902 as redundant upon determining that the device 902 is in the user's hand. Voice I/O in such an example can then remain disabled until hand/finger contact with the edge sensor(s) 910 is lost and/or until voice I/O is manually activated by the user.

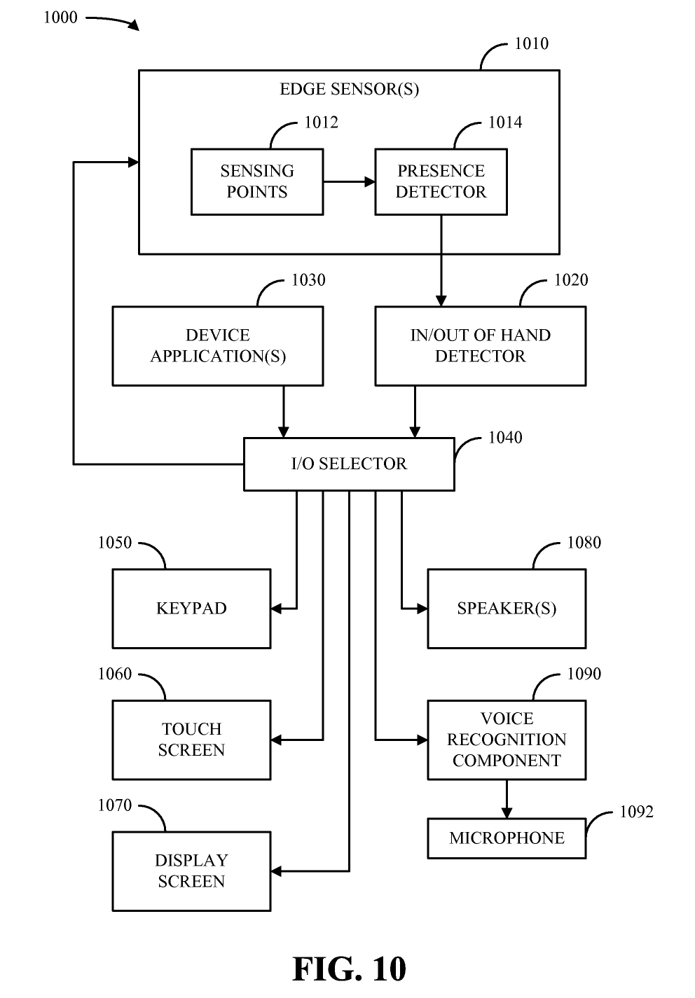

Turning now to FIG. 10, a system 1000 for selecting an input/output mode for an electronic device based on sensor information in accordance with various aspects is illustrated. As FIG. 10 illustrates, system 1000 can include one or more edge sensors 1010, which can be situated along respective edges of a device as generally described herein. In one example, edge sensor(s) 1010 can include an array of sensing points 1012 and/or a presence detector 1014, which can operate as generally described herein to detect the presence or absence of a user's hands and/or fingers on a device. Based on this information, an in/out of hand detector 1020 can be utilized to determine whether the device associated with edge sensor(s) 1010 is in or out of the user's hand.

In accordance with one aspect, based on a determination by the in/out of hand detector 1020, an I/O selector 1040 can be employed to selective enable or disable one or more I/O devices 1050-1092 and/or edge sensor(s) 1010. In one example, the I/O selector 1040 can enable or disable I/O devices 1050-1092 in real time based on changes in the determination provided by in/out of hand detector 1020. Alternatively, changes in enabled and/or disabled I/O devices 1050-1092 can be configured to occur after a predetermined period of time after a change in determination by the in/out of hand detector 1020 and/or at predetermined intervals in time.

In accordance with another aspect, I/O selector 1040 can select one or more I/O devices 1050-1092 in order to optimize operation of an associated device based on its in/out of hand status. For example, if an associated device is determined to be in a user's hand, the I/O selector 1040 can activate one or more physical controls at the device, such as a keypad 1050, a touch-screen 1060, and/or a display screen 1070. In contrast, if the device is determined to be out of a user's hand, the I/O selector 1040 can instead activate one or more I/O devices that do not require physical proximity to the device, such as a speaker 1080, a microphone 1092 (via a voice recognition component 1090), or the like. In one example, speaker(s) 1080 and/or microphone 1092 can be physically located at the device, or alternatively speaker(s) 1080 and/or microphone 1092 can be implemented as one or more standalone entities (e.g., a wireless headset).

In one example, information relating to one or more applications 1030 running on an associated device can additionally be utilized by I/O selector 1040 in determining one or more I/O devices 1050-1092 to select. For example, I/O selector 1040 can be configured to activate the display screen 1070 even if a device is determined to be out of a user's hand if the device is running a video application. As another example, the I/O selector 1040 can activate a speaker 1080 and/or microphone 1092 even if a device is determined to be in a user's hand if the device is engaged in a voice call.

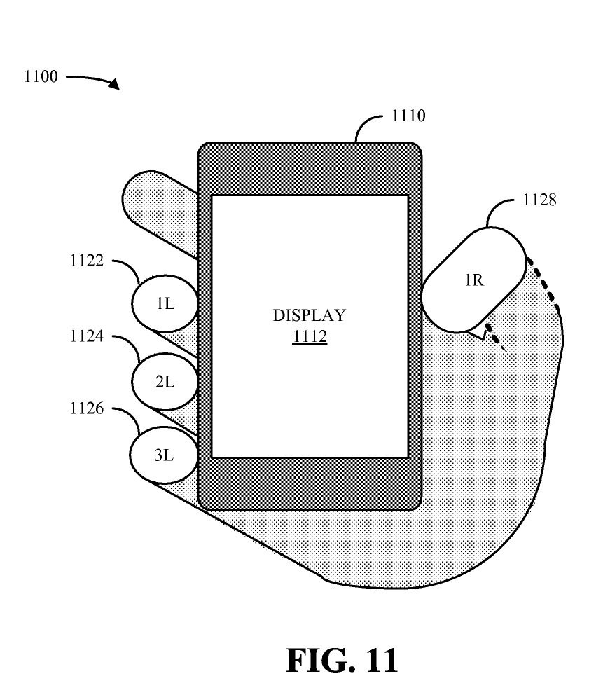

Referring to FIG. 11, a first diagram 1100 is provided that illustrates an example technique for in- and out-of-hand input/output adjustment for an electronic device 1110 in the in-hand case in accordance with various aspects. It should be appreciated that while a generic electronic device 1110 is illustrated in diagram 1100 for simplicity, the technique illustrated by FIG. 11 could be utilized for any suitable electronic device. In accordance with one aspect, device 1100 can determine whether any points of contact are present between a user's hand (e.g., via a user's fingers 1122-1126 and/or thumb 1128) and the device 1100 (e.g., at edge sensors and/or a front touch-screen). If, as illustrated by diagram 1100, points of contact are identified, the device 1100 can activate a display 1112 and enable the display 1112 to provide visual notifications to the user. In one example, display 1112 can remain active until an inactivity timer expires or until a user is no longer contacting the device 1110.

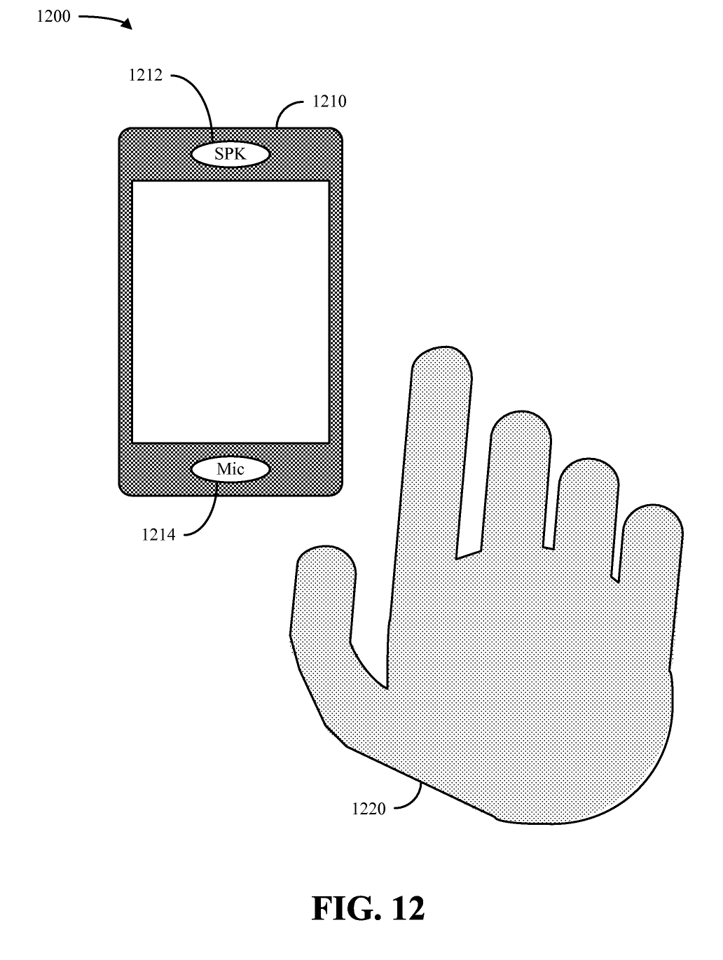

In contrast, a second diagram 1200 is provided in FIG. 12 that illustrates an example technique for in- and out-of-hand input/output adjustment for an electronic device 1210 in the out-of-hand case. In one example, device 1200 can first detect whether points of contact are present between a user's hand 1220 and one or more front, side or back edges of the device 1210. If, as illustrated by diagram 1200, no contact is detected, voice I/O, implemented by a speaker (SPK) 1212 and/or microphone 1214, can be implemented. In one example, if display I/O has been activated at the device 1210 (e.g., via a display 1112), it can be deactivated upon failure to detect points of contact between the user's hand 1220 and the device 1210.

In accordance with one aspect, it should be appreciated that while diagrams 1100 and 1200 illustrate example techniques for I/O adjustment at an electronic device, activation and/or deactivation of display and voice commands and/or notations can be performed based on other suitable factors. For example, one or more applications running at a device can be utilized as a factor in determining an I/O mode to be utilized.

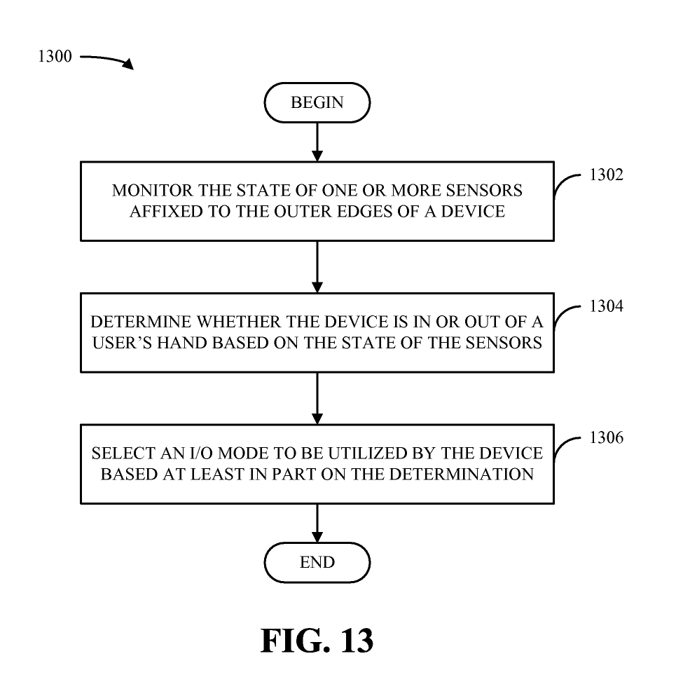

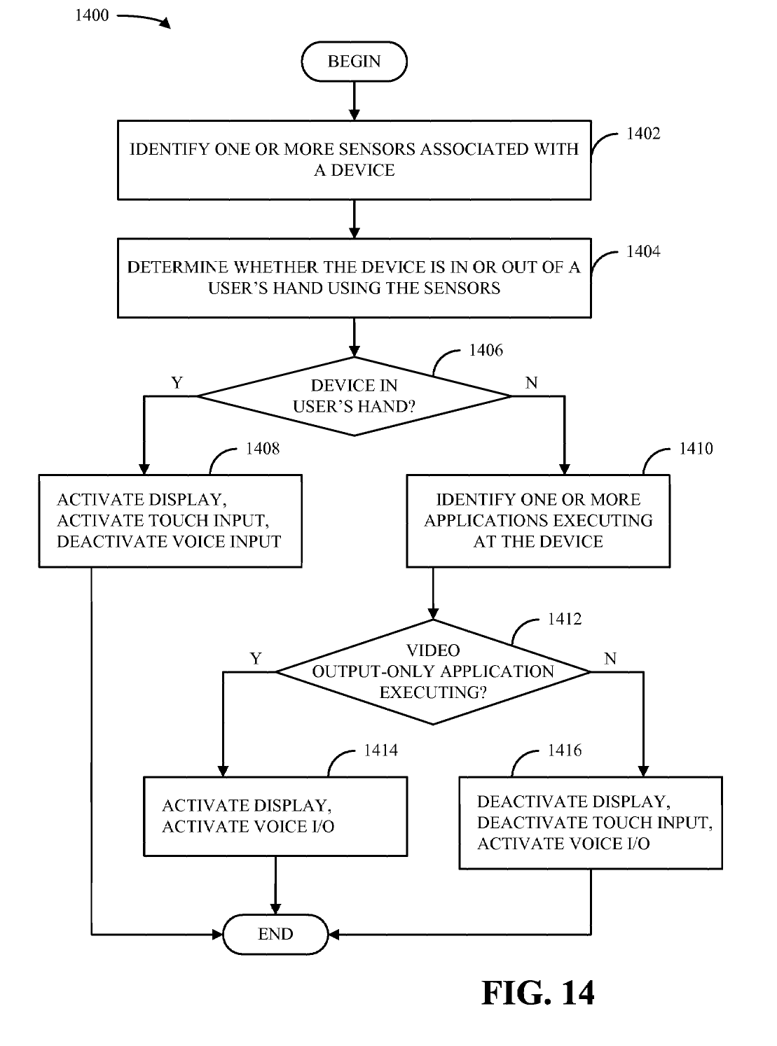

Turning to FIGS. 13-14, methodologies that can be implemented in accordance with various aspects described herein are illustrated via respective series of acts. It is to be appreciated that the methodologies claimed herein are not limited by the order of acts, as some acts may occur in different orders, or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology as claimed herein.

Referring to FIG. 13, a method 1300 for adapting a handheld device (e.g., device 902) for in-hand or out-of-hand operation is illustrated. At 1302, the state of one or more sensors affixed to the outer edges of a device (e.g., edge sensors 910) is monitored. At 1304, it is determined (e.g., by an in/out of hand detector 920) whether the device is in or out of a user's hand based on the state of the sensors as monitored at 1302. At 1306, an I/O mode to be utilized by the device is selected (e.g., by an I/O selector 930) based at least in part on the determination made at 1304.

FIG. 14 illustrates another method 1400 for adapting a device for in-hand or out-of-hand operation. At 1402, one or more sensors (e.g., edge sensors 1010) associated with a device are identified. At 1404, it is determined (e.g., by an in/out of hand detector 1020) whether the device is in or out of a user's hand using the sensors. At 1406, if the device is determined to be in the user's hand, method 1400 proceeds to 1408, wherein a display (e.g., display screen 1070) and touch input (e.g., touch-screen 1060) are activated and voice input (e.g., microphone 1092 and/or voice recognition component 1090) are deactivated. Otherwise, method 1400 proceeds from 1406 to 1410.

At 1410, one or more applications executing at the device (e.g., applications 1030) are identified. Next, at 1412, it is determined whether video output-only applications are executing at the device. If so, method 1400 proceeds to 1414, wherein a display and voice I/O (e.g., speaker(s) 1080, microphone 1092, and/or voice recognition component 1090) are activated. Otherwise, method 1400 proceeds from 1412 to 1416, wherein a display and touch input are deactivated and voice I/O is activated.

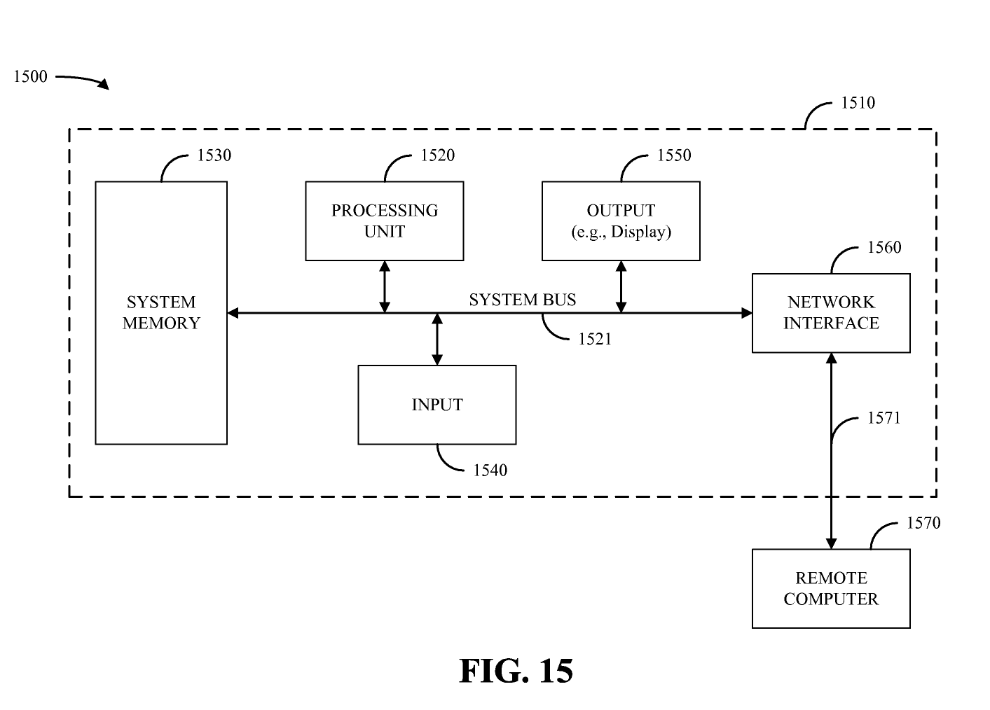

Turning to FIG. 15, an example computing system or operating environment in which various aspects described herein can be implemented is illustrated. One of ordinary skill in the art can appreciate that handheld, portable and other computing devices and computing objects of all kinds are contemplated for use in connection with the claimed subject matter, e.g., anywhere that a network can be desirably configured. Accordingly, the below general purpose computing system described below in FIG. 15 is but one example of a computing system in which the claimed subject matter can be implemented.

Although not required, the claimed subject matter can partly be implemented via an operating system, for use by a developer of services for a device or object, and/or included within application software that operates in connection with one or more components of the claimed subject matter. Software may be described in the general context of computer executable instructions, such as program modules, being executed by one or more computers, such as client workstations, servers or other devices. Those skilled in the art will appreciate that the claimed subject matter can also be practiced with other computer system configurations and protocols.

FIG. 15 thus illustrates an example of a suitable computing system environment 1500 in which the claimed subject matter can be implemented, although as made clear above, the computing system environment 1500 is only one example of a suitable computing environment for a media device and is not intended to suggest any limitation as to the scope of use or functionality of the claimed subject matter. Further, the computing environment 1500 is not intended to suggest any dependency or requirement relating to the claimed subject matter and any one or combination of components illustrated in the example operating environment 1500.

With reference to FIG. 15, an example of a computing environment 1500 for implementing various aspects described herein includes a general purpose computing device in the form of a computer 1510. Components of computer 1510 can include, but are not limited to, a processing unit 1520, a system memory 1530, and a system bus 1521 that couples various system components including the system memory to the processing unit 1520. The system bus 1521 can be any of several types of bus structures including a memory bus or memory controller, a peripheral bus, and a local bus using any of a variety of bus architectures.

Computer 1510 can include a variety of computer readable media. Computer readable media can be any available media that can be accessed by computer 1510. By way of example, and not limitation, computer readable media can comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510. Communication media can embody computer readable instructions, data structures, program modules or other data in a modulated data signal such as a carrier wave or other transport mechanism and can include any suitable information delivery media.

The system memory 1530 can include computer storage media in the form of volatile and/or nonvolatile memory such as read only memory (ROM) and/or random access memory (RAM). A basic input/output system (BIOS), containing the basic routines that help to transfer information between elements within computer 1510, such as during start-up, can be stored in memory 1530. Memory 1530 can also contain data and/or program modules that are immediately accessible to and/or presently being operated on by processing unit 1520. By way of non-limiting example, memory 1530 can also include an operating system, application programs, other program modules, and program data.

The computer 1510 can also include other removable/non-removable, volatile/nonvolatile computer storage media. For example, computer 1510 can include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive can be connected to the system bus 1521 through a non-removable memory interface such as an interface, and a magnetic disk drive or optical disk drive can be connected to the system bus 1521 by a removable memory interface, such as an interface.

A user can enter commands and information into the computer 1510 through input devices such as a keyboard or a pointing device such as a mouse, trackball, touch pad, and/or other pointing device. Other input devices can include a microphone, joystick, game pad, satellite dish, scanner, or the like. These and/or other input devices can be connected to the processing unit 1520 through user input 1540 and associated interface(s) that are coupled to the system bus 1521, but can be connected by other interface and bus structures, such as a parallel port, game port or a universal serial bus (USB). A graphics subsystem can also be connected to the system bus 1521. In addition, a monitor or other type of display device can be connected to the system bus 1521 via an interface, such as output interface 1550, which can in turn communicate with video memory. In addition to a monitor, computers can also include other peripheral output devices, such as speakers and/or a printer, which can also be connected through output interface 1550.

The computer 1510 can operate in a networked or distributed environment using logical connections to one or more other remote computers, such as remote computer 1570, which can in turn have media capabilities different from device 1510. The remote computer 1570 can be a personal computer, a server, a router, a network PC, a peer device or other common network node, and/or any other remote media consumption or transmission device, and can include any or all of the elements described above relative to the computer 1510. The logical connections depicted in FIG. 15 include a network 1571, such as a local area network (LAN) or a wide area network (WAN), but can also include other networks/buses. Such networking environments are commonplace in homes, offices, enterprise-wide computer networks, intranets and the Internet.

When used in a LAN networking environment, the computer 1510 is connected to the LAN 1571 through a network interface or adapter. When used in a WAN networking environment, the computer 1510 can include a communications component, such as a modem, or other means for establishing communications over the WAN, such as the Internet. A communications component, such as a modem, which can be internal or external, can be connected to the system bus 1521 via the user input interface at input 1540 and/or other appropriate mechanism. In a networked environment, program modules depicted relative to the computer 1510, or portions thereof, can be stored in a remote memory storage device. It should be appreciated that the network connections shown and described are non-limiting examples and that other means of establishing a communications link between the computers can be used.

What has been described above includes examples of the claimed subject matter. It is, of course, not possible to describe every conceivable combination of components or methodologies for purposes of describing the claimed subject matter, but one of ordinary skill in the art may recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the described aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates controlling input/output (I/O) mechanisms associated with an electronic device, comprising:
one or more sensors located at respective edges of an electronic device that obtain information relating to presence of fingers or hands of a user relative to the edges of the electronic device;
an in/out of hand detector that determines whether the electronic device is in a hand of the user based on the information obtained from the one or more sensors; and
an I/O selector that selectively activates one or more I/O mechanisms at the electronic device based at least in part on the determination by the in/out of hand detector.

2. The system of claim 1, wherein the I/O selector activates one or more of a touch screen or a display screen and deactivates one or more of a microphone or a speaker upon a determination by the in/out of hand detector that the electronic device is in the hand of the user.

3. The system of claim 1, wherein the I/O selector activates input from the one or more sensors upon a determination by the in/out of hand detector that the electronic device is in the hand of the user.

4. The system of claim 1, wherein the I/O selector activates one or more of a microphone or a speaker and deactivates one or more of a display screen or a touch screen upon a determination by the in/out of hand detector that the electronic device is out of the hand of the user.

5. The system of claim 4, wherein the I/O selector activates one or more of a microphone or a speaker associated with a disparate unit from the electronic device.

6. The system of claim 1, wherein the I/O selector further selectively activates one or more I/O mechanisms at the electronic device based on one or more applications running at the electronic device.

7. The system of claim 6, wherein the I/O selector activates a display screen and one or more speakers upon a determination by the in/out of hand detector that the electronic device is out of the hand of the user and a determination that a video application is running at the electronic device.

8. The system of claim 6, wherein the I/O selector deactivates a display screen and activates input from the one or more sensors, a speaker, and a microphone upon a determination by the in/out of hand detector that the electronic device is in the hand of the user and a determination that a voice communication application is running at the electronic device.

9. The system of claim 1, wherein:
the one or more sensors include respective arrays of sensing points and a presence detector that obtains information relating to presence of contact with the respective arrays of sensing points, and
the in/out of hand detector determines whether the electronic device is in a hand of the user based on the information obtained by the presence detector.

10. The system of claim 1, wherein the electronic device is a mobile telephone handset.

11. The system of claim 1, wherein the electronic device is one or more of a handheld electronic game system or an electronic game controller.

12. A method of adapting an electronic device for in-hand or out-of-hand operation, comprising:
monitoring state of one or more sensors affixed to respective outer edges of an electronic device;
determining whether the electronic device is in or out of a hand of a user based on the monitored state of the one or more sensors; and
selecting an input/output (I/O) mode to be utilized by the electronic device based at least in part on the determination of whether the electronic device is in or out of the hand of the user.

13. The method of claim 12, wherein the selecting comprises activating a display I/O mode upon a determination that the electronic device is in the hand of the user.

14. The method of claim 12, wherein the selecting comprises enabling input at the one or more sensors upon a determination that the electronic device is in the hand of the user.

15. The method of claim 12, wherein the selecting comprises activating a voice I/O mode upon a determination that the electronic device is out of the hand of the user.

16. The method of claim 15, wherein the activating a voice I/O mode comprises enabling one or more microphones or speakers that are separate from the electronic device.

17. The method of claim 15, wherein the selecting comprises selecting an I/O mode to be utilized by the electronic device based at least in part on one or more applications executing at the electronic device.

18. The method of claim 17, wherein the selecting further comprises activating a display and a voice I/O mode upon a determination that the electronic device is out of the hand of the user and that a video application is executing at the electronic device.

19. The method of claim 17, wherein the selecting further comprises disabling a display, activating a voice I/O mode, and enabling input at the one or more sensors upon a determination that the electronic device is in the hand of the user and that a voice communication application is executing at the electronic device.

20. A system that facilitates automatic input/output (I/O) adaptation for a handheld device, comprising:
means for sensing presence of one or more hands or fingers of a user with respect to respective edges of a device;
means for determining whether the device is located in a hand of a user based on the sensing; and
means for selecting and activating one or more display I/O devices or voice I/O devices based on the determination of whether the device is located in a hand of the user.
